(19) United States
(12) Patent Application Publication
(10) Pub. No.: US 2007/0229996 A1
(43) Pub. Date: Oct. 4, 2007

(54) COLOR WHEEL AND ASSEMBLY METHOD THEREOF

(75) Inventors: Tung-Hsing Tsou, Hsinchu (TW); Hsin-Tai Wu, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/623,538

(22) Filed: Jan. 16, 2007

(30) Foreign Application Priority Data
Apr. 4, 2006 (TW) 95111893

(51) Int. Cl. G02B 7/00

(52) U.S. Cl. 359/892; 359/891

(57) ABSTRACT

A color wheel including a first sheet, a second sheet, a ring filter and a motor is provided. The second sheet is disposed opposite to the first sheet, and has positioning pins. The ring filter is disposed between the first sheet and the second sheet, and has a plurality of positioning holes. The positioning pins are disposed through the positioning holes and connected to the first sheet. The motor includes a turntable and an axis connected to the turntable, and a positioning portion is disposed on the top of the axis. The positioning portion includes at least two locking hooks, and a notch is disposed between the locking hooks. The notch is suitable for accommodating the locking hooks with deformation. Moreover, the first sheet, the second sheet and the ring filter are disposed through the axis and fixed on the turntable. The reliability of the color wheel is better.

### CROSS-REFERENCE TO RELATED APPLICATION

This application claims the priority benefit of Taiwan application serial no. 95111893, filed Apr. 4, 2006. All disclosure of the Taiwan application is incorporated herein by reference.

### BACKGROUND OF THE INVENTION

1. Field of the Invention

The present invention relates to a color wheel and assembly method thereof. More particularly, the present invention relates to a color wheel with high reliability and production efficiency and assembly method thereof.

2. Description of Related Art

A common digital light processing (DLP) projection device includes a lighting system, a digital micromirror device (DMD), and a projection lens. The lighting system is adapted to provide a light beam and includes a color wheel and a lens. The light beam after being filtered through the color wheel is converged by the lens and projected on the DMD. The DMD has a plurality of micromirrors which respectively display ON, OFF, or FLAT status so as to convert the light beam into an image light beam. The projection lens is adapted to project the image light beam to display an image on a screen.

Referring to FIG. 1, a conventional color wheel 100 includes a ring filter 110, a washer 120 and a motor 130. The ring filter 110 comprises a plurality of sub-filters 112 in an arrangement. Each sub-filter 112 is individually adhered on the motor 130 by dot gluing, and the sub-filters 112 are not adhered to each other. The washer 120 is disposed above the ring filter 110 and is adhered to the motor 130 by dot gluing. However, as the glue quality is not easy to control and the glue may get deteriorated and carbonized after the long time operation of the motor, the sub-filters 112 may fly out while the motor 130 is rotating in high speed. In addition, as the conventional color wheel 100 is adhered by dot gluing, the assembly condition requires to be controlled accurately, which is time consuming and low throughput. Furthermore, if any of the components are not properly assembled, it can not be reassembled or it is difficult to reassemble, therefore, the quality of the color wheel 100 is not easy to control.

### SUMMARY OF THE INVENTION

Accordingly, the present invention is related to a color wheel, which reduces the possibility of the sub-filters of the ring filter from flying out and thereby improve the reliability.

Other features and advantages of the present invention will be further understood from the further technology features disclosed by the present invention wherein there is shown and described a preferred embodiment of this invention, simply by way of illustration of one of the modes best suited to carry out the invention.

The present invention is also directed to an assembly method of color wheel for improving the reliability and production efficiency of the color wheel.

In order to achieve one, some or all of the aforementioned advantages, one of the embodiments of the present invention provides a color wheel, including a first sheet, a second sheet, a ring filter and a motor. The second sheet is disposed opposite to the first sheet, and has a plurality of positioning pins. The ring filter is disposed between the first sheet and the second sheet, and has a plurality of positioning holes. The positioning pins are disposed through the positioning holes and connected to the first sheet. The motor includes a turntable and an axis connected to the turntable. A positioning portion is disposed on the top of the axis. The positioning portion includes at least two parts, and a gap is disposed between the portions. The gap is suitable for accommodating with the deformation of the parts during assembling the first sheet, the second sheet, and the ring filter on the motor. In addition, the first sheet, the second sheet and the ring filter pass through the positioning portion and rest on the axis, and the parts of the positioning portion are suitable for fixing the first sheet, the second sheet, and the ring filter on the turntable.

In accordance to the one, some or all of aforementioned objects or other objects, another embodiment of the present invention further provides an assembly method. First, a ring filter comprising a plurality of positioning holes formed thereon is provided. The ring filter is disposed in a mold. Next, a first sheet, a second sheet and a plurality of positioning pins are formed in the mold. The multiple positioning pins are suitable for connecting the first sheet and the second sheet through the positioning holes. Next, the first sheet, the second sheet and the ring filter are fixed to a motor.

In accordance with the one, some or all of aforementioned objects or other objects, another embodiment of the present invention further provides a color wheel, including a carrier table, a plurality of sub-filters and a motor. The carrier table has a plurality of protrusions, and the multiple protrusions are disposed adjacent to the surrounding edge of the carrier table. The sub-filters are disposed on the carrier table, and each sub-filter is disposed between the two adjacent protrusions. Each sub-filter has a first positioning notch and a second positioning notch. A part of the side wall in the first positioning notch of each sub-filter is disposed against the inner wall of one of the two adjacent protrusions, and part of the side wall in the second positioning notch is disposed against the outer wall of the other positioning protrusion. Moreover, the motor is fixed to the carrier table and the multiple sub-filters.

In summary, by disposing the positioning pins through the positioning holes or by disposing the sub-filters between the two adjacent protrusions of the carrier table, the possibility of sub-filters flying out due to deterioration of the glue while the motor is rotating in high speed as in the case of conventional technology may be effectively reduced. Therefore, the color wheel of the present invention has better reliability. Moreover, the first sheet, the second sheet, and the ring filter pass through the positioning portion and rest on the axis, to be fixed on the turntable. Therefore, the assembly method of color wheel is simpler and easier.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded view of a conventional color wheel.

FIG. 2A and FIG. 2B are respectively schematic perspective views of the color wheel viewed from different angles according to the first embodiment of the present invention.

FIG. 2C is a cross-sectional diagram of the assembly of the color wheel in FIG. 2A.

FIG. 3 is a schematic block diagram of the assembly method of color wheel according to one embodiment of the present invention.

FIG. 4A and FIG. 4B are schematic diagrams of the formations of the first sheet and the second sheet.

FIG. 5A is an explosion diagram of the color wheel according to a second embodiment of the present invention.

FIG. 5B is a schematic diagram of the color wheel in FIG. 5A.

FIG. 6A and FIG. 6B are the schematic diagrams of the sub-filters and the carrier table in FIG. 5A respectively.

FIG. 6C is a schematic diagram of the assembly of the sub-filters and the carrier table in FIG. 5A.

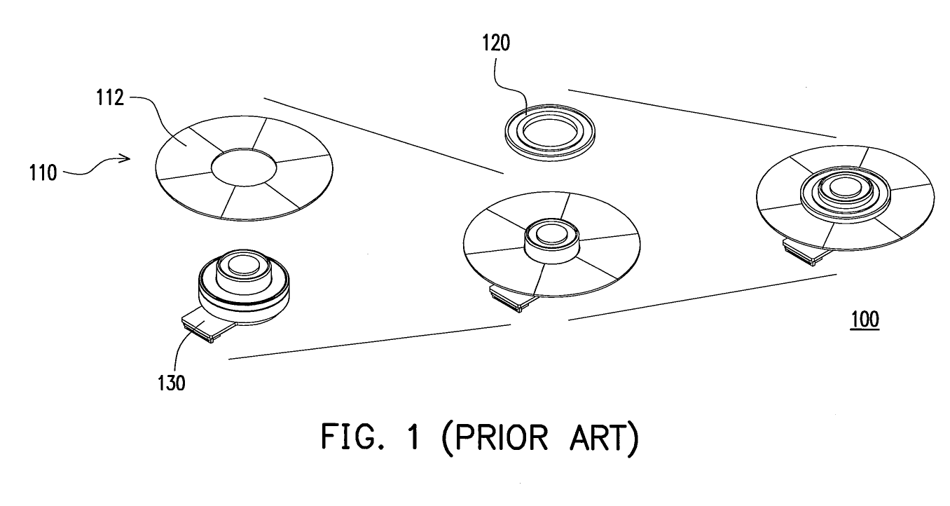

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

### The First Embodiment

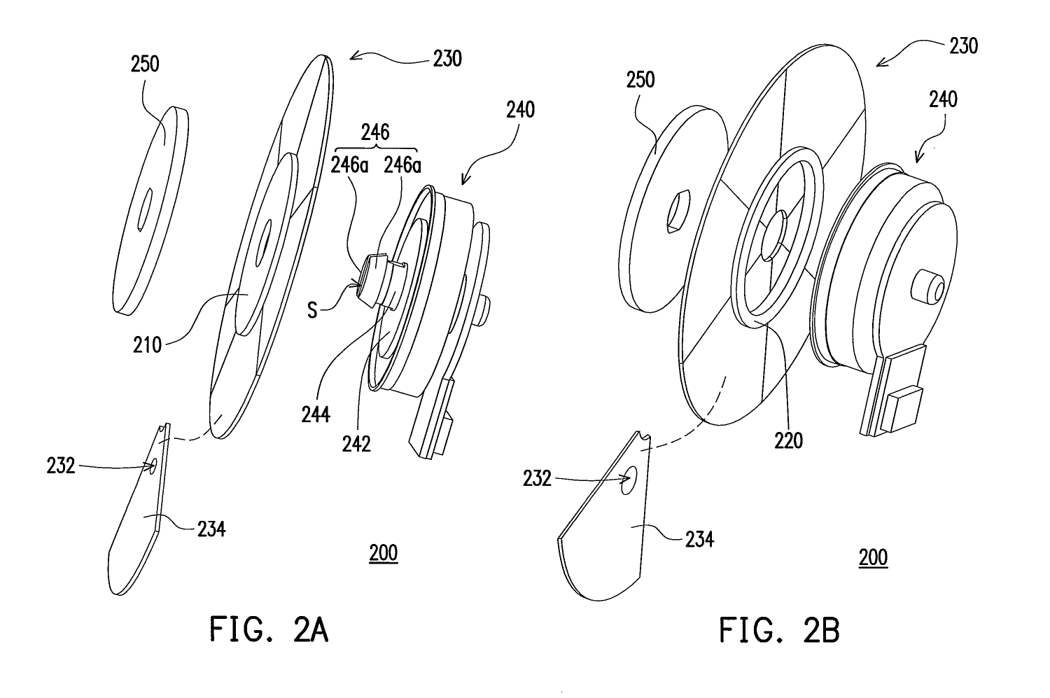

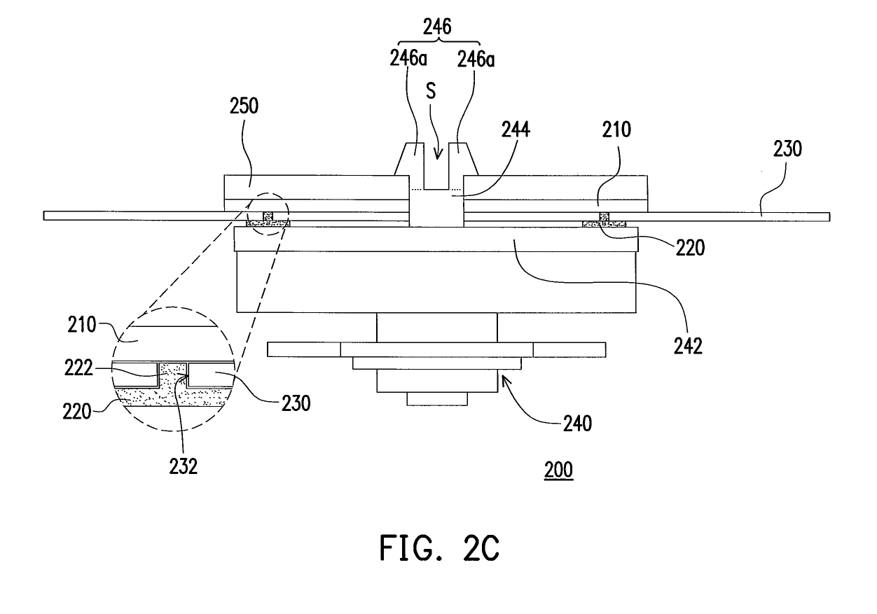

FIG. 2A and FIG. 2B are respectively the schematic perspective views of the color wheel from different view points according to the first embodiment of the present invention, and FIG. 2C is a cross-sectional diagram of the assembly of the color wheel in FIG. 2A. Referring to FIGS. 2A-2C, a color wheel 200 according to the present invention includes a first sheet 210, a second sheet 220, a ring filter 230 and a motor 240. The second sheet 220 is disposed opposite to the first sheet 210 and has a plurality of positioning pins 222. The ring filter 230 is disposed between the first sheet 210 and the second sheet 220, and has a plurality of positioning holes 232. The positioning pins 222 are disposed through the positioning holes 232 and connected to the first sheet 210. The motor 240 includes a turntable 242 and an axis 244 connected to the turntable 242, and at least a first and a second positioning portions 246a, for example. The turntable 242 may be a part of the motor 240, or additional element disposed on the motor 240. A gap S is disposed between the two positioning portions 246a. The gap S is suitable for accommodating with the deformation of the positioning portions 246a. In one embodiment, the positioning portions 246a may be flexible. Therefore, the positioning portions 246a moves toward to the gap during assembling the first sheet 210, the second sheet 220, and the ring filter 230 on to the motor 240. In another embodiment, it is not required that the two positioning portions 246a are flexible and it is enough that one of the positioning portions 246a is flexible. In addition, after assembling the first sheet 210 and the second sheet 220, the ring filter 230 is disposed through the positioning portions 246a and sleeved on the axis 244 so as to fix the first sheet 210, the second sheet 220, and the ring filter 230 on the turntable 242.

The ring filter 230 comprises, for example, a plurality of sub-filters 234 in an arrangement, and the multiple positioning holes 232 are respectively disposed in the sub-filters 234. In one embodiment, the sub-filters 234 are prevented from swaying by the positioning pins 222 disposed through the positioning holes 232 and by being clamped between the first sheet 210 and the second sheet 220, so that the problem that the sub-filters 234 would fly out due to the deterioration of the glue as in the conventional color wheel can be avoided while the motor 240 is rotating in high speed.

Moreover, when the first sheet 210, the second sheet 220 and the ring filter 230 are disposed through the positioning portions 246a to be sleeved on the axis 244 so that the positioning portions 246a are deformed toward the gap S. After the first sheet 210, the second sheet 220, and the ring filter 230 are disposed through the positioning portions 246a and sleeved on the axis 244, the positioning portions 246a recover substantially to their original shape or position for fixing the first sheet 210, the second sheet 220 and the ring filter 230 on the turntable 244. In the preferable embodiment, the first sheet 210 and the ring filter 230 are homocentric, and the diameter of the homocentric cycle is corresponding to the positioning portions 246a so that the first sheet 210, the second sheet 220 and the ring filter 230 are easy to be sleeved and fixed on the axis 244. The first sheet 210, the second sheet 220 and the ring filter 230 are therefore avoided from passing outward through the positioning portion 246 to escape from the motor 240.

In the embodiment, the positioning portion 246 includes two portions 246a to fix the first sheet 210, the second sheet 220 and the ring filter 230. However, the present invention does not limit the number and type of the positioning portions 246a.

The second sheet 220 in the embodiment is disposed on the turntable 242. However, the present invention does not limit the locations of the first sheet 210 and the second sheet 220 relative to the turntable 242. In other words, the first sheet 210 and the second sheet 220 can be exchanged so that the first sheet 210 is disposed on the turntable 242. Moreover, the outside diameter of the first sheet 210 is greater than that of the second sheet 220, however, the outer diameter of the first sheet 210 can also be less than or equal to that of the second sheet 220 in another embodiment.

Referring to FIG. 2A-2C, in one embodiment, in order to fix the first sheet 210, the second sheet 220 and the ring filter 230 on the motor 240 more firmly, the color wheel 200 further includes a washer 250, disposed through the positioning portion 246 and fixed on the axis 244, so that the first sheet 210, the second sheet 220 and the ring filter 230 are fixed between the washer 250 and the turntable 242.

In the embodiment, for assembling the color wheel 200 of the embodiment, the first sheet 210, the second sheet 220 and the ring filter 230 are fixed on the motor 240 by the positioning portion 246 of the axis 244 or the washer 250, but not the glue. Compared to the conventional technology, the assembly is easier and spends less time, and thereby improves the production efficiency. In addition, if any defects are found in the ring filter 230, the first sheet 210 or the second sheet 220, or other structural problem is found after the assembly, it is possible to disassemble to replace or repair and then reassemble.

Although the first sheet 210 and the second sheet 220 described above are separate parts, in another embodiment of the present invention, the first sheet 210 and the second sheet 220 are integrally formed. The assembly method of color wheel of the embodiment accompanied with figures will be described below.

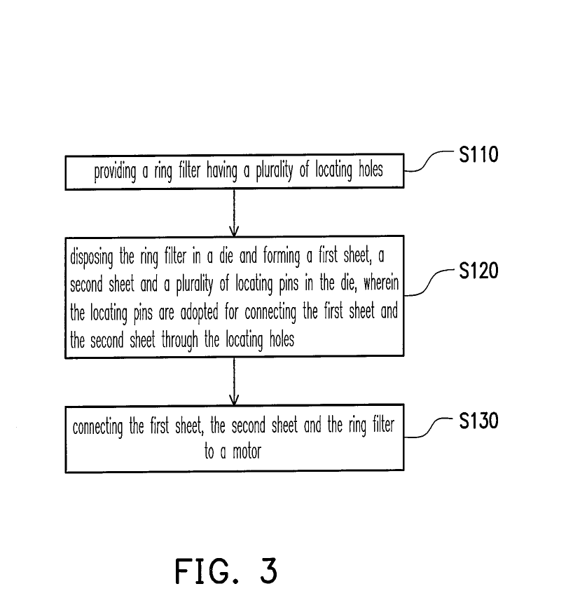

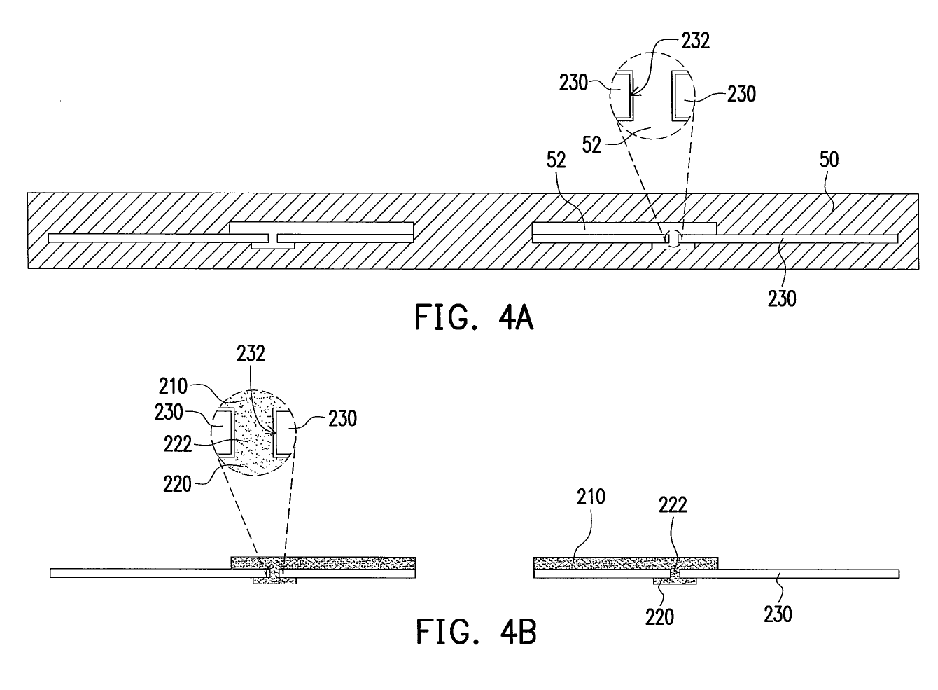

FIG. 3 is a schematic block diagram of the assembly method of color wheel according to one embodiment of the present invention, and FIG. 4A and FIG. 4B are schematic diagrams illustrating the method of forming the first sheet and the second sheet. Referring to FIG. 3 and FIG. 4A-4B, the assembly method of the present invention includes the following steps: first, at step S110, a ring filter 230 having a plurality of positioning holes 232 is provided.

Next, at step S120 and as shown in FIG. 4A, the ring filter 230 is disposed in a mold 50, the mold 50 has a cavity 52 suitable for injecting a mold material. Then, as shown in FIG. 4B, a first sheet 210, a second sheet 220 and a plurality of positioning pins 222 for connecting the first sheet 210 and the second sheet 220 are formed in the cavity 52 of the mold 50 using injection molding process, and the positioning pins 222 are disposed through the positioning holes 232. Accordingly, the time for assembling the first sheet 210, the second sheet 220 and the ring filter 230 is saved, and the production efficiency is improved. It should be noted that the present invention is not limit to the process of forming the first sheet 210 and the second sheet 220 using injection molding.

Next, as shown in the process S130, a motor is provided, and the first sheet 210, the second sheet 220 and the ring filter 230 are fixed on the motor. The fixing method can be the aforementioned fixing method, however, the fixing method is not limited as such.

### The Second Embodiment

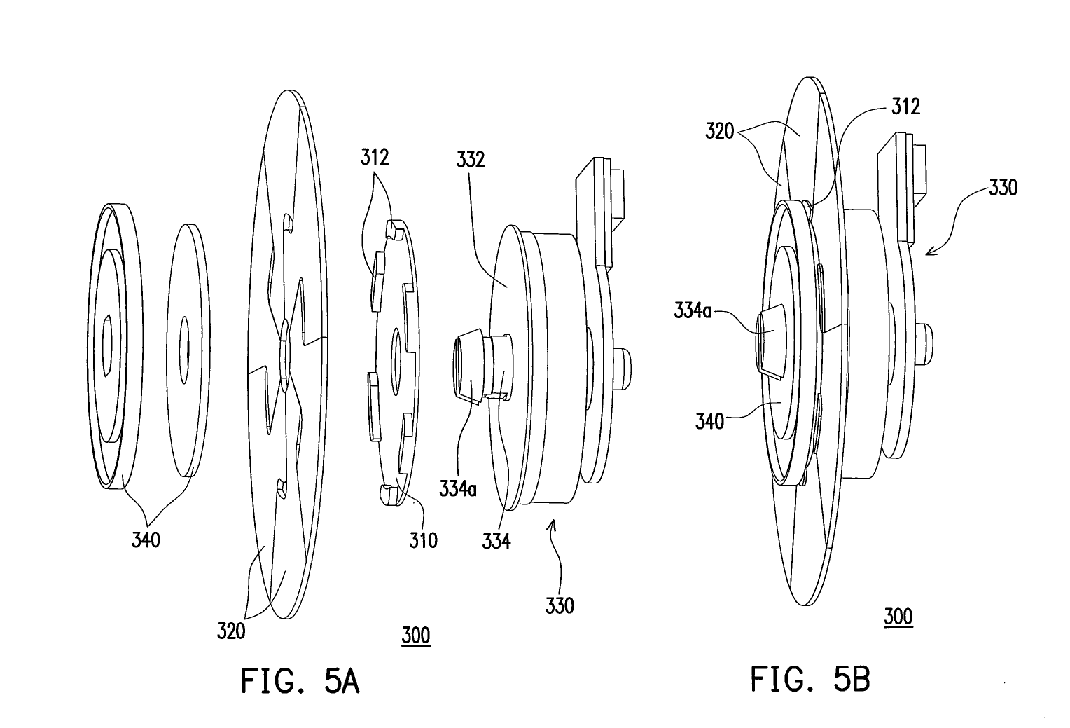

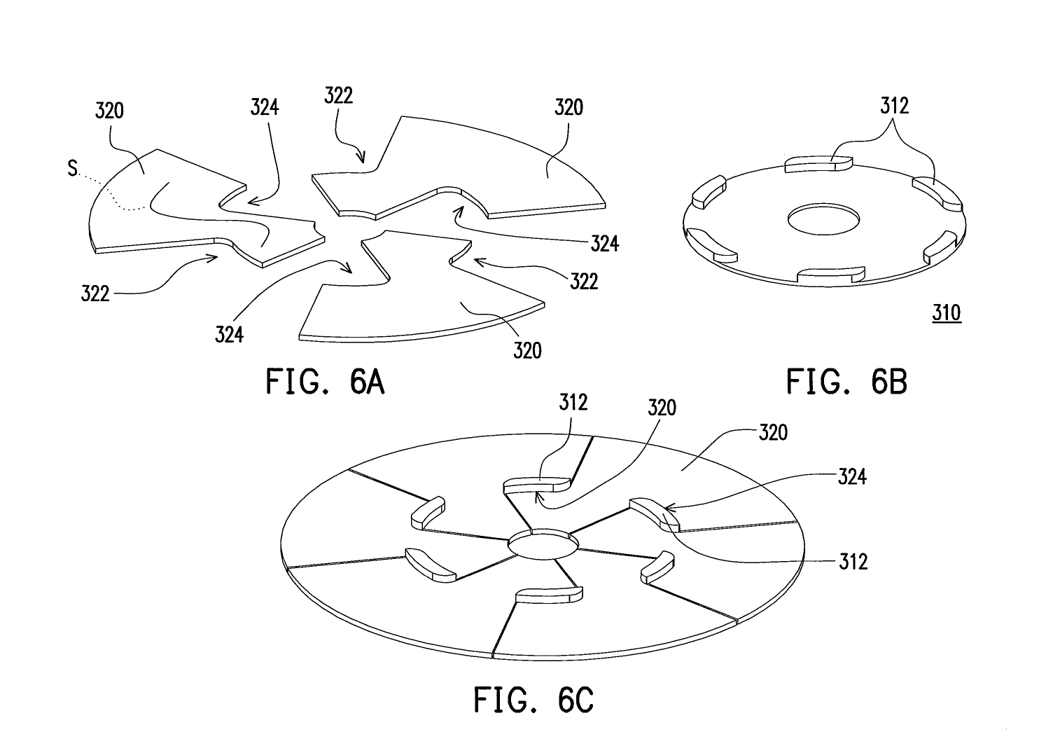

FIG. 5A is an explosion diagram of a color wheel according to a second embodiment of the present invention, and FIG. 5B is a schematic view of the color wheel in FIG. 5A. FIG. 6A and FIG. 6B are respectively schematic views of the sub-filter and the carrier table in FIG. 5A, and FIG. 6C is a schematic view of the assembly of the sub-filter and the carrier table in FIG. 5A. Referring to FIG. 5A and FIG. 5B, the color wheel 300 in the embodiment includes a carrier table 310, a plurality of sub-filters 320 and a motor 330. The sub-filters 320 are fixed on the carrier table 310, and the carrier table 310 is fixed on the motor 330.

Referring to FIG. 5A, FIG. 6A, and FIG. 6B, the sub-filters 320, for example, form a ring filter, the outline of each sub-filter 320 is, for example, S-shaped, and each sub-filter 320 has a first notch 322 and a second notch 324. Moreover, the carrier table 310 has a plurality of protrusions 312, and the protrusions 312 are disposed adjacent to the edge of the carrier table 310. In one embodiment, the protrusions 312 are disposed on the surrounding edge of the carrier table 310 and it is one of the examples of the protrusions 312 being disposed adjacent to the edge of the carrier table 310. It should be noted that, although the number of the sub-filters 320 in the embodiment is 6 and the number of the protrusions 312 is also 6 in order to correspond to the sub-filters 320, however, the present invention is not limited to specific number of the sub-filters 320 and the protrusions 312. In addition, for illustratively demonstrating the embodiment of the present invention, only three sub-filters 320 are shown in FIG. 6A.

Referring to FIG. 6C, in the embodiment, the sub-filters 320 are disposed on the carrier table 310 and between the two adjacent protrusions 312. A part of the side wall of the first notch 322 of each sub-filter 320 is disposed on the inner wall of one of the two adjacent protrusions 312, and the side wall of the second notch is disposed on the outer wall of another positioning protrusion 312.

Referring to FIG. 5A, FIG. 5B and FIG. 6C, in the embodiment, the carrier table 310 and the sub-filters 320 are fixed on the motor 330. The motor 330 includes a turntable 332 and an axis 334, and a positioning portion 334a is disposed on the top of the axis 334 so that the carrier table 310 and the sub-filters 320 are fixed between the turntable 332 and the positioning portion 334a. In one embodiment, the positioning portion 334a includes for example two portions with a gap formed between the two parts. The diameter of the two portions of the positioning portion preferably shrinks from the bottom connected to the axis 334 to the top. Similar to the first embodiment mentioned above, the two portions of the positioning portion are preferably flexible or deformable for easily assembling the carrier table 310 and the sub-filters 320 on the turntable 332. The turntable 332 may be a part of the motor 330, or additional element disposed on the motor 330. Moreover, the color wheel 300 further includes at least a washer 340, disposed through the axis 334, so that the carrier table 310 and the sub-filters 320 can be fixed on the motor 330 more firmly.

In addition, in the embodiment, a motor with a first screw thread and a washer with a second screw thread matching the first screw thread are used to fix the carrier table 310 and the sub-filters 320 between the washer and the carrier table.

In the color wheel 300 of the embodiment, as the sub-filters 320 are disposed between the two adjacent protrusions 312 of the carrier table 310, the interaction force between the protrusion 312 and the first notch 322, the second notch 324 counter the centrifugal force generated when the motor is rotating, and thereby provide better support. Therefore, the sub-filters 320 are properly secured and do not fly out even while the motor is rotating in high speed. Therefore, the color wheel 300 of the embodiment has better reliability.

In summary, the embodiments of the color wheel and assembly method thereof in the present invention has at least one or more of the following advantages:

1. As the positioning pins are disposed through the positioning holes and the sub-filters are fixed by being clamped between the first sheet and the second sheet, the usage of glue can be avoided, therefore, the possibility of the sub-filters flying out due to the deterioration of the glue when the motor is rotating in high speed as in the conventional technology may be effectively reduced.

2. As the sub-filters are disposed between the two adjacent protrusions of the carrier table, the usage of glue can be avoided, so that the possibility of the sub-filters from flying out due to the deterioration of the glue when the motor is rotating in high speed as in the case of the conventional technology may be effectively reduced.

3. When assembling, the color wheel is aligned by the positioning holes or by the sub-filters and the positioning protrusions of the carrier table, therefore the assembly is easier and spends less time compared to the conventional technology, thereby improves production efficiency and the throughput of the color wheel.

4. As the first sheet and the second sheet are integrally formed, the time for assembling the first sheet, the second sheet and the ring filter can be saved, and thereby improves the production efficiency.

5. As the use of glue is not required in the assembly of the color wheel of the present invention, it is easy to disassemble for repairing or replacing defective components and then reassemble.

6. The positioning protrusions are deformed toward the gap when being forced, and it is helpful for the first sheet, the second sheet and the ring filter to pass through the positioning protrusions directly. After the first sheet, the second sheet, and the ring filter passing through the positioning protrusions, the positioning protrusions can fix the first sheet, the second sheet, and the ring filter on the motor. Therefore, the assembly method of the color wheel is simpler compared to the conventional art.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A color wheel, comprising:
a first sheet;
a second sheet disposed opposite to the first sheet and comprising a plurality of positioning pins;
a ring filter comprising a plurality of positioning holes, disposed between the first sheet and the second sheet, wherein the positioning pins are disposed through the positioning holes and connected to the first sheet; and
a motor, comprising a turntable and an axis connected to the turntable, wherein a first positioning portion and a second positioning portion are disposed on the top of the axis, and a gap is disposed between the first positioning portion and second positioning portion,
wherein, the first sheet, the second sheet and the ring filter are disposed through the positioning portions and sleeved on the axis for fixing the first sheet, the second sheet, and the ring filter on the turntable.

2. The color wheel as claimed in claim 1, wherein the ring filter comprises a plurality of sub-filters, and the positioning holes are disposed in the sub-filters respectively.

3. The color wheel as claimed in claim 1, wherein the first sheet and the second sheet are integrally formed.

4. The color wheel as claimed in claim 1, further comprising a washer disposed through the axis, and the first sheet, the second sheet, and the ring filter are disposed between the washer and the turntable.

5. The color wheel as claimed in claim 1, wherein at least one of the first positioning portion and the second positioning portion is flexible.

6. The color wheel as claimed in claim 1, wherein the first positioning portion and the second positioning portion is deformable.

7. An assembly method of color wheel, comprising:
providing a ring filter, wherein the ring filter comprises a plurality of positioning holes;
disposing the ring filter in a mold, and forming a first sheet, a second sheet and a plurality of positioning pins in the mold, wherein the positioning pins are adopted for connecting the first sheet and the second sheet through the positioning holes; and
connecting the first sheet, the second sheet and the ring filter to a motor.

8. The assembly method of color wheel as claimed in claim 7, wherein the first sheet, the second sheet, and the positioning pins are formed by performing an injection molding process.

9. A color wheel, comprising:
a carrier table, having a plurality of protrusions disposed adjacent to a peripheral edge of the carrier table;
a plurality of sub-filters, each sub-filter disposed on the carrier table and between the two adjacent protrusions, comprising a first notch and a second notch, wherein a part of a side wall in the first notch of each sub-filter is disposed against an inner wall of one of the two adjacent protrusions, and a part of a side wall in the second notch is disposed against an outer wall of another protrusion; and
a motor, fixed to the carrier table and the sub-filters.

10. The color wheel as claimed in claim 9, wherein the motor comprises a turntable and an axis connected to the turntable, and the carrier table is sleeved on the axis.

11. The color wheel as claimed in claim 10, wherein a first positioning portion and a second positioning portion are disposed on a top of the axis for fixing the sub-filters and the carrier table on the turntable.

12. The color wheel as claimed in claim 11, wherein a diameter of the first positioning portion and the second positioning portion shrinks from the bottom to the top.

13. The color wheel as claimed in claim 11, further comprising a washer, sleeved on the axis, wherein the sub-filters and the carrier table are disposed between the washer and the turntable.

14. The color wheel as claimed in claim 10, further comprising a washer, wherein the axis has a first screw thread and a second screw thread coupled to the first screw thread is disposed on an inner wall of the washer, and the washer is screwed onto the axis for fixing the sub-filters and the carrier table between the washer and the turntable.

15. The color wheel as claimed in claim 9, wherein the sub-filters comprise S-shape.

16. The color wheel as claimed in claim 11, wherein at least one of the first positioning portion and the second positioning portion is flexible.

17. The color wheel as claimed in claim 11, wherein the first positioning portion and the second positioning portion are deformable.
